(19) United States
(12) Patent Application Publication
(10) Pub. No.: US 2002/0010123 A1
(43) Pub. Date: Jan. 24, 2002

(54) Laundry detergents and cleaning products

(76) Inventors: Peter Schmiedel, Duesseldorf (DE); Maren Jekel, Duesseldorf (DE); Thomas Otto Gassenmeier, Duesseldorf (DE); Wolfgang Von Rybinski, Duesseldorf (DE); Arnd Kessler, Leverkusen (DE); Christian Nitsch, Duesseldorf (DE); Rolf Bayersdoerfer, Landau (DE); Bernd Richter, Leichlingen (DE); Matthias Sunder, Duesseldorf (DE); Thomas Holderbaum, Monheim (DE)

Correspondence Address: Glenn E.J. Murphy, Henkel Corporation, Patent Law Dept., 2500 Renaissance Blvd., Suite 200, Gulph Mills, PA, 19406, US

(21) Appl. No.: 09/731,395

(22) Filed: Dec. 4, 2000

(30) Foreign Application Priority Data
Dec. 4, 1999 (DE) 199 58 471. 0
Apr. 20, 2000 (DE) 100 19 936.4

(51) Int. Cl. C11D 17/00

(52) U.S. Cl. 510/446; 510/451; 510/470; 510/473; 510/477

(57) ABSTRACT

Claimed are laundry detergents and cleaning products which comprise customary ingredients and, characteristically, further comprise an active substance preparation which has been compounded with an LCST substance. By means of compounding with an LCST substance it is possible to incorporate active substances which, in a washing or cleaning process which passes through one or more temperature stages, are released only after a heat treatment, e.g., only in a rinse cycle.

The present invention relates to a laundry detergent or cleaning product comprising customary ingredients and also an active substance preparation comprising the active substance plus an LCST substance.

The controlled release of active substances has a part to play wherever the active substance is intended to develop its activity not immediately after being supplied but instead only at a particular point in time of a process. In many cases, the active substances which are to be added only at a later stage must be supplied manually.

In the pharmaceutical sector, the different dissolution behavior of polymers in the acidic and alkaline medium, i.e., as in the stomach and in the intestine, is used with active substances intended for peroral administration by using such polymers to coat tablets etc. Drugs intended to pass into the intestine are commonly coated with a polymer which is resistant to gastric fluid and which dissolves only in the intestine.

In other processes, temperature curves are traversed, as for example with the sterilization and pasteurization of foodstuffs.

Washing and cleaning processes also feature a number of heating and cooling phases. Different active substances are added especially in the last process stage, e.g., the last wash cycle of a washing machine or the last wash cycle of a dishwasher, known as the rinse cycle. In the customary washing and cleaning processes, these active substances are generally added as separate compositions but are not present in the actual detergent.

International Patent Application WO 98/49910 discloses an encapsulated material, at least part of the material being present in encapsulated form during a heat treatment in an aqueous environment and being released after cooling following this heat treatment. This material is coated with a layer comprising a hydrophobic film-forming material and with a layer comprising a material having a lower critical separation temperature (LCST polymer) which lies below the temperature of the heat treatment. The encapsulated materials are used in sterilization processes within the food industry.

It is an object of the present invention to provide a laundry detergent of cleaning product which comprises an active substance which, in a washing or cleaning process which passes through one or more temperature stages, is released only after a heat treatment, e.g., only in a rinse cycle.

It has surprisingly been found that active substances in washing and cleaning processes can be released specifically only in a rinse cycle if these active substances to be incorporated into the compositions are compounded with an LCST substance.

The present invention provides a laundry detergent or cleaning product comprising customary ingredients, further comprising an active substance preparation which has been compounded with an LCST substance.

The present invention also provides a laundry detergent or cleaning product comprising customary active substances and ingredients, in which the active substances have been compounded at least in part with an LCST polymer, wherein a fraction of the active substances has been applied to carrier materials.

For the purposes of the present invention, laundry detergents or cleaning products embrace, in particular, machine dishwashing compositions, rinse aids for machine dishwashing compositions; textile detergents and also textile aftertreatment compositions, these compositions being able to comprise exclusively active substances which are to be released only in a process stage following the actual cleaning or laundering, and which are therefore not available during the actual cleaning or washing operation.

LCST substances are substances which have a better solubility at low temperatures than at higher temperatures. They are also referred to as substances having a lower critical separation temperature.

For the purposes of the present invention, an active substance preparation is a preparation comprising an active substance with or without further ingredients which has been compounded with an LCST substance. In one possible embodiment, the preparation is coated or enveloped with the LCST substance. In another embodiment, the LCST substance acts as matrix material for the active substance.

In one embodiment of the present invention, a fraction of the active substances has been applied to carrier materials or mixed with carrier materials. It has proven advantageous to apply substances, especially liquid and sensitive active substances and ingredients, first to carrier materials and then to process them further.

Carrier materials for the active substances and ingredients may be selected from all materials known from the prior art which are suitable for producing compacted particles. It is evident to the skilled worker that they are able to act simultaneously as carrier material for these substances and also as binders in tablets or particles produced from them.

Suitable carrier materials are all substances which are solid at room temperature and which have a sufficient absorption capacity for the active substance(s). It is also possible to select substances which develop an additional activity in the cleaning cycle, builders being particularly appropriate. As carrier materials it is possible, for example, to use substances from the group consisting of solid laundry detergent and cleaning product ingredients, preferably zeolites, bentonites, silicates, such as water glasses, disilicates, carbonates, e.g., alkali metal carbonates, hydrogen carbonates, sulfates, phosphates, and also synthetic polymers, such as polyethylene glycols, for example, especially solid polyethylene glycols, polycarboxylates, crosslinked polycarboxylates, polyvinyl alcohols with different degrees of hydrolysis and molecular weight, or polyvinylpyrrolidone, polyvinyl acetate, and organic oligocarboxylic acids which are solid at room temperature. The LCST polymers used may also be suitable carrier materials.

The active substance preparation may be compounded in a conventional manner which depends on the formulation of the finished composition. Preparation may take place, for example, by simple mixing of the individual ingredients. It is also possible to extrude or to granulate the ingredients of the preparation. Where the LCST substance is applied as a coating, the individual ingredients of the preparation may be precompounded as granules or extrudates and then coated. The active substances may also be prepared in the form of capsules, in which case the LCST polymer itself may form the capsule wall, or else is applied subsequently to a capsule containing the active substance. It need not necessarily be a single capsule which is involved. It is also possible to use an assembly of capsules, formed for example by bonding or compression of individual capsules. Processing of the material by tableting is likewise possible.

In a further embodiment, the LCST substance forms a matrix material. In this embodiment, for example, it is possible to produce an active substance mixture which is coated with an LCST substance. The resulting mixtures may be present, on the one hand, in the form of granules and may subsequently be processed to a tablet in conventional manner, such as by compression, in the presence or absence of further ingredients. On the other hand, it is also possible to process the mixture further in the form of a sol or a melt.

The laundry detergent or cleaning product may be used with particular advantage in machine processes where the active substance is to be released in a wash cycle following the washing step. Examples are the machine laundering of textiles and the machine washing of kitchenware and tableware, both domestically and in the commercial sector. As a result of the compounding of the invention, the active substances remain at least partly unchanged following a heat treatment in a liquid medium, e.g., following the main wash cycle, and the active substance is released only after cooling following the heat treatment, i.e., in the rinse cycle.

In accordance with the present invention, the active substance intended for delayed release is compounded with an LCST substance. LCST substances are substances which have a better solubility at low temperatures than at higher temperatures. They are also referred to as substances having a lower critical separation temperature. These substances are generally polymers. Depending on service conditions, the lower critical separation temperature should be situated between room temperature and the temperature of the heat treatment, for example, between 20° C., preferably 30° C. and 100° C., in particular between 30° C. and 50° C. The LCST substances are preferably selected from alkylated and/or hydroxyalkylated polysaccharides, cellulose ethers, polyisopropylacrylamide, copolymers of polyisopropylacrylamide, and blends of these substances.

Examples of alkylated and/or hydroxyalkylated polysaccharides are methylhydroxypropylmethylcellulose (MHPC), ethyl(hydroxyethyl)cellulose (EHEC), hydroxypropylcellulose (HPC), methylcellulose (MC), ethylcellulose (EC), carboxylmethylcellulose (CMC), carboxymethylmethylcellulose (CMMC), hydroxybutylcellulose (HBC), hydroxybutylmethylcellulose (HBMC), hydroxyethylcellulose (HEC), hydroxyethylcarboxymethylcellulose (HECMC), hydroxyethylethylcellulose (HEEC), hydroxypropylcellulose (HPC), hydroxypropylcarboxymethylcellulose (HPCMC), hydroxyethylmethylcellulose (HEMC), methylhydroxyethylcellulose (MHEC), methylhydroxyethylpropylcellulose (MHEPC), methylcellulose (MC),and propylcellulose (PC) and mixtures thereof, preference being given to carboxymethylcellulose, methylcellulose, methylhydroxyethylcellulose and methylhydroxypropylcellulose and also to the alkali metal salts of CMC and the slightly ethoxylated MCs or mixtures of the above.

Further examples of LCST substances are cellulose ethers and also mixtures of cellulose ethers with carboxymethylcellulose (CMC). Further polymers which exhibit a lower critical separation temperature in water and which are likewise suitable are polymers of mono- or di-N-alkylated acrylamides, copolymers of mono- or di-N-substituted acrylamides with acrylates and/or acrylic acids, or mixtures of interpenetrating networks of the aforementioned (co)polymers. Also suitable are polyethylene oxide or copolymers thereof, such as ethylene oxide/propylene oxide copolymers and graft copolymers of alkylated acrylamides with polyethylene oxide, polymethacrylic acid, polyvinyl alcohol and copolymers thereof, polyvinyl methyl ethers, certain proteins such as poly(VATGVV), a repeating unit in the natural protein elastin, and certain alginates. Mixtures of these polymers with salts or surfactants may likewise be used as LCST substances. The LCST (lower critical separation temperature) may be modified appropriately by means of such additions or by the degree of crosslinking of the polymers.

In one preferred embodiment of the present invention, the active substances used in accordance with the invention are coated with a further material which is soluble at a temperature above the lower separation temperature of the LCST substance or which has a melting point above this temperature or a retarded solubility, i.e., can be released above the lower separation temperature of the LCST coat. The purpose of this coat is to protect the mixture of active substance and LCST substance against water or other media which may dissolve them prior to the heat treatment. This further coat should be non-liquid at room temperature and preferably has a melting point or softening point at a temperature which lies at or above the lower critical separation temperature of the LCST polymer. With particular preference, the melting point of this coat is situated between the lower critical separation temperature and the temperature of the heat treatment. In one particular configuration of this embodiment, the LCST polymers and the further substance are mixed with one another and applied to the material to be encapsulated.

The further substance preferably has a melting range which lies between about 35° C. and about 75° C. In the present case, this means that the melting range occurs within the stated temperature interval, and does not refer to the breadth of the melting range.

Preferred substances which may be applied as a further coat are hydrophilic polymers, such as polyvinyl alcohols, polyethylene glycols, polyvinylpyrrolidone, water-soluble polysaccharides, water-soluble polyurethanes, xanthan, guar gum, alginates, chitosan, carrageenan, polyacrylates and copolymers thereof. Shellac as well, such as Schellack-KPS-Dreiring-SP (Kalkhoff GmbH), for example, may be used as further substance.

The abovementioned properties are in general possessed by what are called waxes. The term “waxes” is applied to a range of natural or synthetic substances which melt without decomposition, generally at above 35° C., and are of comparatively low viscosity, without stringing, even at just a little above the melting point. They have a highly temperature-dependent consistency and solubility. According to their origin, the waxes are divided into three groups: the natural waxes, chemically modified waxes, and the synthetic waxes.

The natural waxes include, for example, plant waxes such as candelilla wax, carnauba wax, Japan wax, esparto grass wax, cork wax, guaruma wax, rice germ oil wax, sugar cane wax, ouricury wax, or montan wax, animal waxes such as beeswax, shellac wax, spermaceti, lanolin (wool wax), or uropygial grease, mineral waxes such as ceresin or ozokerite (earth wax), or petrochemical waxes such as petrolatum, paraffin waxes or microcrystalline waxes.

The chemically modified waxes include, for example, hard waxes such as montan ester waxes, sassol waxes, or hydrogenated jojoba waxes.

By synthetic waxes are meant, in general, polyalkylene waxes or polyalkylene glycol waxes. As coating materials it is also possible to use compounds from other classes of substance which meet the stated requirements in terms of softening point. Examples of synthetic compounds which have proven suitable are higher esters of phthalic acid, especially dicyclohexyl phthalate, which is available commercially under the name Unimoll® 66 (Bayer AG). Also suitable are synthetically prepared waxes from lower carboxylic acids and fatty alcohols, an example being dimyristyl tartrate, which is available under the name Cosmacol® ETLP (Condea). Conversely, synthetic or partially synthetic esters of lower alcohols with fatty acids from natural sources may also be used. This class of substance includes, for example, Tegin® 90 (Goldschmidt), a glyceryl monostearate palmitate. Shellac as well, for example, Schellack-KPS-Dreiring-SP (Kalkhoff GmbH), may be used as a further substance.

Likewise counted among the waxes in the context of the present invention are, for example, the so-called wax alcohols. Wax alcohols are relatively high molecular mass, water-insoluble fatty alcohols having in general from about 22 to 40 carbon atoms. The wax alcohols occur, for example, in the form of wax esters of relatively high molecular mass fatty acids (wax acids) as a principal constituent of many natural waxes. Examples of wax alcohols are lignoceryl alcohol (1-tetracosanol), cetyl alcohol, myristyl alcohol, and melissyl alcohol. The coating may, if desired, also include wool wax alcohols, by which are meant triterpenoid and steroid alcohols, an example being lanolin, which is available under the commercial designation Argowax® (Pamentier & Co.), for example. Likewise possible for use, at least proportionally, as a constituent of the coating are, in the context of the present invention, fatty acid glycerol esters or fatty acid alkanolamides, and also, if desired, water-insoluble or only sparingly water-soluble polyalkylene glycol compounds.

Further suitable substances having a melting point above the LCST of the underlying coating material are saturated aliphatic hydrocarbons (paraffins).

Further suitable coating materials include all water-soluble, water-dispersible and water-insoluble polymers which have a melting point which lies above the lower critical separation temperature of the LCST polymer used in accordance with the invention or which are soluble above this temperature. Suitable polymers are room-temperature-solid polyethylene glycols, polyvinyl alcohols, polyacrylic acid and derivatives thereof. Gelatin has also proven suitable.

Occasionally, protection of the LCST polymer layer may be sufficiently effected just by shielding it from initially cold water by means of a water-soluble coating. This water-soluble coating need only have a sufficiently retarded solubility so that the layer is stable for a sufficient time. For this purpose it is possible, for example, to use polyalkylene glycols whose molecular weight, preferably, is relatively high.

Where the compounding of the active substances with the LCST substance is carried out by applying the LCST substance as a coating, in a further embodiment of the present invention it is possible first to coat the active substances with a coat of a water-soluble polymer, e.g., polyvinyl alcohol, to which the LCST substance is applied subsequently.

The water-soluble polymer acts as a protective coat for the active substances and is intended to prevent the diffusive penetration of water and thus premature dissolution and release of said substances. It is evident to the skilled worker that the application of further coats below the LCST substance coating is also possible when the active substances are compounded without a carrier substance.

The active substance used which is intended for retarded release may be processed, i.e., compounded, in a manner known per se with the LCST substance and/or the further material. Where the substances are applied as a coating to the active substance and/or to the preparation, the substances may be applied by spraying in the form, for example, of a melt or of a solution or dispersion, or the mixture may be immersed in the melt, solution or dispersion, or may be mixed therewith in an appropriate mixer. Coating in a fluidized bed apparatus is a further option. In the case of the spraying method, suitable processes are all those which are established in pharmacy and food technology for the production of coated tablets, capsules and particles. The polymer suspension or solution is applied by spraying either batchwise, in small portions, with the particles being transported on a conveyer belt, for example, through a mist of liquid and subsequently dried in a stream of air, or continuously, with simultaneous drying by means of the inblown stream of air in fluidized bed or flotation coating apparatuses. Also conceivable is the film coating process, if LCST polymers in sufficiently high concentration are added to the coating syrups. The second coat is applied analogously.

An essential advantage of the laundry detergent or cleaning product of the invention is that active substances which are to be released in a process stage following a heating step, i.e., in the rinse cycle, need not be added separately. The majority of washing and cleaning operations, both in the commercial sector and domestically, pass through different temperature stages. Especially in the case of machine operations, the so-called rinse cycles which follow a washing or cleaning stage at elevated temperature are generally accompanied by the addition of further components. These later process stages are generally rinse cycles, in which the user, depending on the operation, adds certain active substances. These active substances are generally added separately, either manually or by way of devices intended specially for the purpose. With these processes as well, the use of the active substances compounded in accordance with the invention offers a large number of advantages.

Active substances considered for use in laundry detergents and cleaning products include enzymes, fragrances, dyes, acids and halogen- or oxygen-based bleaches, as well as bleach activators and bleaching catalysts. Machine dishwashing compositions further comprise, in particular, rinse aid surfactants and corrosion inhibitors. Textile detergents generally include the aforementioned components plus active substances comprising fluorescence agents, optical brighteners, shrink preventatives, textile handle agents, anticrease agents, antimicrobial active substances, germicides, fungicides, antioxidants, antistats, easy-iron agents, repellency and impregnating agents, and also UV absorbers and fragrances. In accordance with the invention, these active substances are compounded with an LCST substance and may be incorporated into the composition of the invention. In the wash process, they are released in a rinse cycle following the main wash cycle.

In addition to the active substances, the laundry detergents and cleaning products comprise as further ingredients, for example, surfactants, preferably selected from anionic, nonionic, cationic, and amphoteric surfactants. The surfactants are present preferably in an amount of from 0.1 to 50% by weight, based on the composition.

Nonionic surfactants used are preferably alkoxylated, advantageously ethoxylated, especially primary, alcohols having preferably 8 to 18 carbon atoms and on average from 1 to 12 mol of ethylene oxide (EO) per mole of alcohol, in which the alcohol radical may be linear or, preferably, methyl-branched in position 2 and/or may comprise linear and methyl-branched radicals in a mixture, as are commonly present in oxo alcohol radicals. In particular, however, preference is given to alcohol ethoxylates containing linear radicals from alcohols of natural origin having 12 to 18 carbon atoms, e.g., from coconut, palm, tallow fatty or oleyl alcohol and on average from 2 to 8 EO per mole of alcohol. Preferred ethoxylated alcohols include, for example, C₁₂₋₁₄ alcohols containing 3 EO to 7 EO, C₉₋₁₁ alcohol containing 7 EO, C₁₃₋₁₅ alcohols containing 3 EO, 5 EO, 7 EO or 8 EO, C₁₂₋₁₈ alcohols containing 3 EO, 5 EO or 7 EO, and mixtures thereof, such as mixtures of C₁₂₋₁₄ alcohol containing 3 EO and C₁₂₋₁₈ alcohol containing 7 EO. The stated degrees of ethoxylation represent statistical mean values, which for a specific product may be an integer or a fraction. Preferred alcohol ethoxylates have a narrowed homolog distribution (narrow range ethoxylates, NREs). In addition to these nonionic surfactants it is also possible to use fatty alcohols containing more than 12 EO. Examples thereof are tallow fatty alcohol containing 14 EO, 25 EO, 30 EO or 40 EO. Also suitable for use in accordance with the invention are nonionic surfactants containing EO and PO groups together in the molecule. In this context, use may be made of block copolymers containing EO-PO block units or PO-EO block units, but also EO-PO-EO copolymers and PO-EO-PO copolymers. It is of course also possible to use nonionic surfactants with mixed alkoxylation in which EO and PO units are distributed not in blocks but randomly. Such products are obtainable by the simultaneous action of ethylene oxide and propylene oxide on fatty alcohols.

As further nonionic surfactants, furthermore, use may also be made of alkyl glycosides of the general formula RO(G)ₓ, where R is a primary straight-chain or methyl-branched aliphatic radical, especially an aliphatic radical methyl-branched in position 2, containing 8 to 22, preferably 12 to 18, carbon atoms, and G is the symbol representing a glycose unit having 5 or 6 carbon atoms, preferably glucose. The degree of oligomerization, x, which indicates the distribution of monoglycosides and oligoglycosides, is any desired number between 1 and 10; preferably, x is from 1.2 to 1.4.

A further class of nonionic surfactants used are alkoxylated, preferably ethoxylated, or ethoxylated and propoxylated, fatty acid alkyl esters, preferably having 1 to 4 carbon atoms in the alkyl chain, especially fatty acid methyl esters.

Nonionic surfactants of the amine oxide type, examples being N-cocoalkyl-N,N-dimethylamine oxide and N-tallowalkyl-N,N-dihydroxyethylamine oxide, and of the fatty acid alkanolamide type, may also be suitable. The amount of these nonionic surfactants is preferably not more than that of the ethoxylated fatty alcohols, in particular not more than half thereof.

Further suitable surfactants are polyhydroxy fatty acid amides of the formula (III)

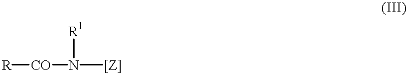

where RCO is an aliphatic acyl radical having 6 to 22 carbon atoms, R¹ is hydrogen or an alkyl or hydroxyalkyl radical having 1 to 4 carbon atoms, and [Z] is a linear or branched polyhydroxyalkyl radical having 3 to 10 carbon atoms and from 3 to 10 hydroxyl groups. The polyhydroxy fatty acid amides are known substances which are customarily obtainable by reductive amination of a reducing sugar with ammonia, an alkylamine or an alkanolamine, and subsequent acylation with a fatty acid, a fatty acid alkyl ester or a fatty acid chloride.

The group of the polyhydroxy fatty acid amides also includes compounds of the formula (IV)

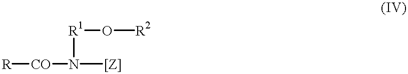

where R is a linear or branched alkyl or alkenyl radical having 7 to 12 carbon atoms, R¹ is a linear, branched or cyclic alkyl radical or an aryl radical having 2 to 8 carbon atoms and R² is a linear, branched or cyclic alkyl radical or an aryl radical or an oxyalkyl radical having 1 to 8 carbon atoms, preference being given to C₁₋₄ alkyl radicals or phenyl radicals, and [Z] is a linear polyhydroxyalkyl radical whose alkyl chain is substituted by at least two hydroxyl groups, or alkoxylated, preferably ethoxylated or propoxylated, derivatives of said radical.

[Z] is preferably obtained by reductive amination of a sugar, e.g., glucose, fructose, maltose, lactose, galactose, mannose or xylose. The N-alkoxy- or N-aryloxy-substituted compounds may be converted to the desired polyhydroxy fatty acid amides by reaction with fatty acid methyl esters in the presence of an alkoxide as catalyst, for example.

Anionic surfactants used are, for example, those of the sulfonate and sulfate type. Preferred surfactants of the sulfonate type are C₉₋₁₃ alkylbenzenesulfonates, olefinsulfonates, i.e., mixtures of alkenesulfonates and hydroxyalkanesulfonates, and also disulfonates, as are obtained, for example, from C₁₂₋₁₈ monoolefins having a terminal or internal double bond by sulfonating with gaseous sulfur trioxide followed by alkaline or acidic hydrolysis of the sulfonation products. Also suitable are alkanesulfonates, which are obtained from C₁₂₋₁₈ alkanes, for example, by sulfochlorination or sulfoxidation with subsequent hydrolysis or neutralization, respectively. Likewise suitable, in addition, are the esters of α-sulfo fatty acids (ester sulfonates), e.g., the α-sulfonated methyl esters of hydrogenated coconut, palm kernel or tallow fatty acids.

Preferred alk(en)yl sulfates are the alkali metal salts, and especially the sodium salts, of the sulfuric monoesters of C₁₂-C₁₈ fatty alcohols, examples being those of coconut fatty alcohol, tallow fatty alcohol, lauryl, myristyl, cetyl or stearyl alcohol, or of C₁₀-C₂₀ oxo alcohols, and those monoesters of secondary alcohols of these chain lengths. Preference is also given to alk(en)yl sulfates of said chain length which contain a synthetic straight-chain alkyl radical prepared on a petrochemical basis. From a detergents standpoint, the C₁₂-C₁₆ alkyl sulfates and C₁₂-C₁₅ alkyl sulfates, and also C₁₄-C₁₅ alkyl sulfates, are preferred. In addition, 2,3-alkyl sulfates are suitable anionic surfactants.

Further suitable anionic surfactants are sulfated fatty acid glycerol esters. Fatty acid glycerol esters are the monoesters, diesters and triesters, and mixtures thereof, as obtained in the preparation by esterification of a monoglycerol with from 1 to 3 mol of fatty acid or in the transesterification of triglycerides with from 0.3 to 2 mol of glycerol. Preferred sulfated fatty acid glycerol esters are the sulfation products of saturated fatty acids having 6 to 22 carbon atoms, examples being those of caproic acid, caprylic acid, capric acid, myristic acid, lauric acid, palmitic acid, stearic acid, or behenic acid.

Also suitable are the sulfuric monoesters of the straight-chain or branched C₇₋₂₁ alcohols ethoxylated with from 1 to 6 mol of ethylene oxide, such as 2-methyl-branched C₉₋₁₁ alcohols containing on average 3.5 mol of ethylene oxide (EO) or C₁₂₋₁₈ fatty alcohols containing from 1 to 4 EO. Because of their high foaming behavior they are used in surfactant or detergent compositions only in relatively small amounts, for example, in amounts of from 1 to 5% by weight.

Further suitable anionic surfactants include the salts of alkylsulfosuccinic acid, which are also referred to as sulfosuccinates or as sulfosuccinic esters and which constitute monoesters and/or diesters of sulfosuccinic acid with alcohols, preferably fatty alcohols and especially ethoxylated fatty alcohols. Preferred sulfosuccinates comprise C₈₋₁₈ fatty alcohol radicals or mixtures thereof. Especially preferred sulfosuccinates contain a fatty alcohol radical derived from ethoxylated fatty alcohols which themselves represent nonionic surfactants (for description, see below). Particular preference is given in turn to sulfosuccinates whose fatty alcohol radicals are derived from ethoxylated fatty alcohols having a narrowed homolog distribution. Similarly, it is also possible to use alk(en)ylsuccinic acid having preferably 8 to 18 carbon atoms in the alk(en)yl chain, or salts thereof.

Further suitable anionic surfactants are, in particular, soaps, which are used in particular at relatively high pH. Suitable soaps include saturated and unsaturated fatty acid soaps, such as the salts of lauric acid, myristic acid, palmitic acid, stearic acid, hydrogenated erucic acid and behenic acid, and, in particular, mixtures of soaps derived from natural fatty acids, e.g., coconut, palm kernel, olive oil or tallow fatty acids.

The anionic surfactants, including the soaps, may be present in the form of their sodium, potassium or ammonium salts and also as soluble salts of organic bases, such as mono-, di- or triethanolamine. Preferably, the anionic surfactants are in the form of their sodium or potassium salts, in particular in the form of the sodium salts.

A further group of ingredients are the builders. The laundry and cleaning products of the invention may comprise all of the builders commonly used in detergents, i.e., in particular, zeolites, silicates, carbonates, organic cobuilders, and/or phosphates.

Suitable crystalline, layered sodium silicates possess the general formula NaMSiₓO₂ₓ₊₁.yH₂O, where M is sodium or hydrogen, x is a number from 1.9 to 4, y is a number from 0 to 20, and preferred values for x are 2, 3 or 4. Crystalline phyllosilicates of this kind are described, for example, in European Patent Application EP-A-0 164 514. Preferred crystalline phyllosilicates of the formula indicated are those in which M is sodium and x adopts the value 2 or 3. In particular, both β- and δ-sodium disilicates Na₂Si₂O₅.yH₂O are preferred.

It is also possible to use amorphous sodium silicates having an Na₂O:SiO₂ modulus of from 1:2 to 1:3.3, preferably from 1:2 to 1:2.8, and in particular from 1:2 to 1:2.6, which are dissolution-retarded and have secondary washing properties. The retardation of dissolution relative to conventional amorphous sodium silicates may have been brought about in a variety of ways—for example, by surface treatment, compounding, compacting, or overdrying. In the context of this invention, the term “amorphous” also embraces “X-ray-amorphous”. This means that in X-ray diffraction experiments the silicates do not yield the sharp X-ray reflections typical of crystalline substances but instead yield at best one or more maxima of the scattered X-radiation, having a width of several degree units of the diffraction angle. However, even particularly good builder properties may result if the silicate particles in electron diffraction experiments yield vague or even sharp diffraction maxima. The interpretation of this is that the products have microcrystalline regions with a size of from 10 to several hundred nm, values up to max. 50 nm and in particular up to max. 20 nm being preferred. So-called X-ray-amorphous silicates of this kind possess retarded dissolution relative to the conventional water glasses. Particular preference is given to compacted amorphous silicates, compounded amorphous silicates, and overdried X-ray-amorphous silicates.

The finely crystalline, synthetic zeolite used, containing bound water, is preferably zeolite A and/or P. A particularly preferred zeolite P is Zeolite MAP® (commercial product from Crosfield). Also suitable, however, are zeolite X and also mixtures of A, X and/or P. Another product available commercially and able to be used with preference in the context of the present invention, for example, is a cocrystallizate of zeolite X and zeolite A (approximately 80% by weight zeolite X), which is sold by CONDEA Augusta S.p.A. under the brand name VEGOBOND AX® and may be described by the formula

nNa₂O·(1−n)K₂O.Al₂O₃·(2-2.5)SiO₂·(3.5-5.5)H₂O.

Suitable zeolites have an average particle size of less than 10 μm (volume distribution; measurement method: Coulter counter) and contain preferably from 18 to 22% by weight, in particular from 20 to 22% by weight, of bound water.

Of course, the widely known phosphates may also be used as builder substances provided such a use is not to be avoided on ecological grounds. Among the large number of commercially available phosphates, the alkali metal phosphates, with particular preference being given to pentasodium and pentapotassium triphosphate (sodium and potassium tripolyphosphate, respectively), possess the greatest importance in the detergents industry.

Alkali metal phosphates is the collective term for the alkali metal (especially sodium and potassium) salts of the various phosphoric acids, among which metaphosphoric acids (HPO₃)ₙ and orthophosphoric acid H₃PO₄, in addition to higher-molecular-mass representatives, may be distinguished. The phosphates combine a number of advantages: they act as alkali carriers, prevent limescale deposits on machine components, and lime encrustations on fabrics, and additionally contribute to cleaning performance.

Sodium dihydrogen phosphate, NaH₂PO₄, exists as the dihydrate (density 1.91 g cm⁻³, melting point 600) and as the monohydrate (density 2.04 g cm⁻³). Both salts are white powders of very ready solubility in water which lose the water of crystallization on heating and undergo conversion at 200° C. into the weakly acidic diphosphate (disodium dihydrogen diphosphate, Na₂H₂P₂O₇) and at a higher temperature into sodium trimetaphosphate (Na₃P₃O₉) and Maddrell's salt (see below). NaH₂PO₄ reacts acidically; it is formed if phosphoric acid is adjusted to a pH of 4.5 using sodium hydroxide solution and the slurry is sprayed. Potassium dihydrogen phosphate (primary or monobasic potassium phosphate, potassium biphosphate, PDP), KH₂PO₄, is a white salt with a density of 2.33 g cm⁻³, has a melting point of 253° [decomposition with formation of potassium polyphosphate (KPO₃)ₓ], and is readily soluble in water.

Disodium hydrogen phosphate (secondary sodium phosphate), Na₂HPO₄, is a colorless, crystalline salt which is very readily soluble in water. It exists in anhydrous form and with 2 mol (density 2.066 g cm⁻³, water loss at 950), 7 mol (density 1.68 g cm⁻³, melting point 480 with loss of 5 H₂O), and 12 mol (density 1.52 g cm³, melting point 35° with loss of 5 H₂O) of water, becomes anhydrous at 100°, and if heated more intensely undergoes transition to the diphosphate Na₄P₂O₇. Disodium hydrogen phosphate is prepared by neutralizing phosphoric acid with sodium carbonate solution using phenolphthalein as indicator. Dipotassium hydrogen phosphate (secondary or dibasic potassium phosphate), K₂HPO₄, is an amorphous white salt which is readily soluble in water.

Trisodium phosphate, tertiary sodium phosphate, Na₃PO₄, exists as colorless crystals which as the dodecahydrate have a density of 1.62 g cm⁻³ and a melting point of 73-76° C. (decomposition), as the decahydrate (corresponding to 19-20% P₂O₅) have a melting point of 100° C., and in anhydrous form (corresponding to 39-40% P₂O₅) have a density of 2.536 g cm³. Trisodium phosphate is readily soluble in water, with an alkaline reaction, and is prepared by evaporative concentration of a solution of precisely 1 mol of disodium phosphate and 1 mol of NaOH. Tripotassium phosphate (tertiary or tribasic potassium phosphate), K₃PO₄, is a white, deliquescent, granular powder of density 2.56 g cm⁻³ has a melting point of 1340°, and is readily soluble in water with an alkaline reaction. It is produced, for example, when Thomas slag is heated with charcoal and potassium sulfate. Despite the relatively high price, the more readily soluble and therefore highly active potassium phosphates are frequently preferred in the detergents industry over the corresponding sodium compounds.

Tetrasodium diphosphate (sodium pyrophosphate), Na₄P₂O₇, exists in anhydrous form (density 2.534 g cm⁻³, melting point 988°, 880° also reported) and as the decahydrate (density 1.815-1.836 g cm⁻³, melting point 94° with loss of water). Both substances are colorless crystals which dissolve in water with an alkaline reaction. Na₄P₂O₇ is formed when disodium phosphate is heated to >200° or by reacting phosphoric acid with sodium carbonate in stoichiometric ratio and dewatering the solution by spraying. The decahydrate complexes heavy metal salts and water hardeners and therefore reduces the hardness of the water. Potassium diphosphate (potassium pyrophosphate), K₄P₂O₇, exists in the form of the trihydrate and is a colorless, hygroscopic powder of density 2.33 g cm⁻³ which is soluble in water, the pH of the 1% strength solution at 25° being 10.4.

Condensation of NaH₂PO₄ or of KH₂PO₄ gives rise to higher-molecular-mass sodium and potassium phosphates, among which it is possible to distinguish cyclic representatives, the sodium and potassium metaphosphates, and catenated types, the sodium and potassium polyphosphates. For the latter in particular a large number of names are in use: fused or calcined phosphates, Graham's salt, Kurrol's and Maddrell's salt. All higher sodium and potassium phosphates are referred to collectively as condensed phosphates.

The industrially important pentasodium triphosphate, Na₅P₃O₁₀ (sodium tripolyphosphate), is a nonhygroscopic, white, water-soluble salt which is anhydrous or crystallizes with 6 H₂O and has the general formula NaO—[P(O)(ONa)—O]ₙ—Na where n=3. About 17 g of the anhydrous salt dissolve in 100 g of water at room temperature, about 20 g at 600, around 32 g at 1000; after heating the solution at 100° C. for two hours, about 8% orthophosphate and 15% diphosphate are produced by hydrolysis. For the preparation of pentasodium triphosphate, phosphoric acid is reacted with sodium carbonate solution or sodium hydroxide solution in stoichiometric ratio and the solution is dewatered by spraying. In a similar way to Graham's salt and sodium diphosphate, pentasodium triphosphate dissolves numerous insoluble metal compounds (including lime soaps, etc.). Pentapotassium triphosphate, K₅P₃O₁₀ (potassium tripolyphosphate), is commercialized, for example, in the form of a 50% strength by weight solution (>23% P₂O₅, 25% K₂O). The potassium polyphosphates find broad application in the detergents industry. There also exist sodium potassium tripolyphosphates, which may likewise be used for the purposes of the present invention. These are formed, for example, when sodium trimetaphosphate is hydrolyzed with KOH:

(NaPO₃)₃+2KOH→Na₃K₂P₃O₁₀+H₂O

They can be used in accordance with the invention in precisely the same way as sodium tripolyphosphate, potassium tripolyphosphate, or mixtures of these two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphospate, may also be used in accordance with the invention.

Organic cobuilders which may be used in the machine dishwashing compositions of the invention are, in particular, polycarboxylates/polycarboxylic acids, polymeric polycarboxylates, aspartic acid, polyacetals, dextrins, further organic cobuilders (see below), and phosphonates. These classes of substance are described below.

Organic builder substances which may be used are, for example, the polycarboxylic acids usable in the form of their sodium salts, the term polycarboxylic acids meaning those carboxylic acids which carry more than one acid function. Examples of these are citric acid, adipic acid, succinic acid, glutaric acid, malic acid, tartaric acid, maleic acid, fumaric acid, sugar acids, amino carboxylic acids, nitrilotriacetic acid (NTA), provided such use is not objectionable on ecological grounds, and also mixtures thereof. Preferred salts are the salts of the polycarboxylic acids such as citric acid, adipic acid, succinic acid, glutaric acid, tartaric acid, sugar acids, and mixtures thereof.

The acids per se may also be used. In addition to their builder effect, the acids typically also possess the property of an acidifying component and thus also serve to establish a lower and milder pH of detergents. In this context, mention may be made in particular of citric acid, succinic acid, glutaric acid, adipic acid, gluconic acid, and any desired mixtures thereof.

Also suitable as builders are polymeric polycarboxylates; these are, for example, the alkali metal salts of polyacrylic acid or of polymethacrylic acid, examples being those having a relative molecular mass of from 500 to 70,000 g/mol.

The molecular masses reported for polymeric polycarboxylates, for the purposes of this document, are weight-average molecular masses, M_{w}, of the respective acid form, determined basically by means of gel permeation chromatography (GPC) using a UV detector. The measurement was made against an external polyacrylic acid standard, which owing to its structural similarity to the polymers under investigation provides realistic molecular weight values. These figures differ markedly from the molecular weight values obtained using polystyrenesulfonic acids as the standard. The molecular masses measured against polystyrenesulfonic acids are generally much higher than the molecular masses reported in this document.

Suitable polymers are, in particular, polyacrylates, which preferably have a molecular mass of from 2000 to 20,000 g/mol. Owing to their superior solubility, preference in this group may be given in turn to the short-chain polyacrylates, which have molecular masses of from 2000 to 10,000 g/mol, and with particular preference from 3000 to 5000 g/mol.

Also suitable are copolymeric polycarboxylates, especially those of acrylic acid with methacrylic acid and of acrylic acid or methacrylic acid with maleic acid. Copolymers which have been found particularly suitable are those of acrylic acid with maleic acid which contain from 50 to 90% by weight of acrylic acid and from 50 to 10% by weight of maleic acid. Their relative molecular mass, based on free acids, is generally from 2000 to 70,000 g/mol, preferably from 20,000 to 50,000 g/mol, and in particular from 30,000 to 40,000 g/mol.

The (co)polymeric polycarboxylates can be used either as powders or as aqueous solutions. The (co)polymeric polycarboxylate content of the compositions is preferably from 0.5 to 20% by weight, in particular from 3 to 10% by weight.

In order to improve the solubility in water, the polymers may also contain allylsulfonic acids, such as allyloxybenzenesulfonic acid and methallylsulfonic acid, for example, as monomers.

Particular preference is also given to biodegradable polymers comprising more than two different monomer units, examples being those comprising, as monomers, salts of acrylic acid and of maleic acid, and also vinyl alcohol or vinyl alcohol derivatives, or those comprising, as monomers, salts of acrylic acid and of 2-alkylallylsulfonic acid, and also sugar derivatives.

Further preferred copolymers are those whose monomers are preferably acrolein and acrylic acid/acrylic acid salts, and, respectively acrolein and vinyl acetate. Similarly, further preferred builder substances that may be mentioned include polymeric amino dicarboxylic acids, their salts or their precursor substances. Particular preference is given to polyaspartic acids and their salts and derivatives.

Further suitable builder substances are polyacetals, which may be obtained by reacting dialdehydes with polyol carboxylic acids having 5 to 7 carbon atoms and at least 3 hydroxyl groups. Preferred polyacetals are obtained from dialdehydes such as glyoxal, glutaraldehyde, terephthalaldehyde and mixtures thereof and from polyol carboxylic acids such as gluconic acid and/or glucoheptonic acid.

Further suitable organic builder substances are dextrins, examples being oligomers and polymers of carbohydrates, which may be obtained by partial hydrolysis of starches. The hydrolysis can be conducted by customary processes, for example, acid-catalyzed or enzyme-catalyzed processes. The hydrolysis products preferably have average molecular masses in the range from 400 to 500,000 g/mol. Preference is given here to a polysaccharide having a dextrose equivalent (DE) in the range from 0.5 to 40, in particular from 2 to 30, DE being a common measure of the reducing effect of a polysaccharide in comparison to dextrose, which possesses a DE of 100. It is possible to use both maltodextrins having a DE of between 3 and 20 and dried glucose syrups having a DE of between 20 and 37, and also so-called yellow dextrins and white dextrins having higher molecular masses, in the range from 2000 to 30,000 g/mol.

The oxidized derivatives of such dextrins comprise their products of reaction with oxidizing agents which are able to oxidize at least one alcohol function of the saccharide ring to the carboxylic acid function. An oxidized oligo saccharide is likewise suitable, a product oxidized at C₆ of the saccharide ring being particularly advantageous.

Oxydisuccinates and other derivatives of disuccinates, preferably ethylenediamine disuccinate, are further suitable cobuilders. Ethylenediamine N,N′-disuccinate (EDDS) is used preferably in the form of its sodium or magnesium salts. Further preference in this context is given to glycerol disuccinates and glycerol trisuccinates as well. Suitable use amounts in formulations containing zeolite and/or silicate are from 3 to 15% by weight.

Examples of further useful organic cobuilders are acetylated hydroxy carboxylic acids and their salts, which may also, if desired, be present in lactone form and which contain at least 4 carbon atoms, at least one hydroxyl group, and not more than two acid groups.

A further class of substance having cobuilder properties is represented by the phosphonates. The phosphonates in question are, in particular, hydroxyalkane- and aminoalkanephosphonates. Among the hydroxyalkanephosphonates, 1-hydroxyethane-1,1-diphosphonate (HEDP) is of particular importance as a cobuilder. It is used preferably as the sodium salt, the disodium salt being neutral and the tetrasodium salt giving an alkaline (pH 9) reaction. Suitable aminoalkanephosphonates are preferably ethylenediaminetetramethylenephosphonate (EDTMP), diethylenetriaminepentamethylenephosphonate (DTPMP), and their higher homologs. They are used preferably in the form of the neutrally reacting sodium salts, e.g., as the hexasodium salt of EDTMP or as the hepta- and octa-sodium salt of DTPMP. As a builder in this case, preference is given to using HEDP from the class of the phosphonates. Furthermore, the aminoalkanephosphonates possess a pronounced heavy metal binding capacity. Accordingly, and especially if the compositions also contain bleach, it may be preferred to use aminoalkanephosphonates, especially DTPMP, or to use mixtures of said phosphonates.

Furthermore, all compounds capable of forming complexes with alkaline earth metal ions may be used as cobuilders.

A further class of active substances which may be present in the compositions of the invention are bleaches, which may be selected from the group consisting of oxygen bleaches or halogen bleaches, especially the chlorine bleaches.

Among the compounds used as bleaches which yield H₂O₂ in water, particular importance is possessed by sodium perborate tetrahydrate and sodium perborate monohydrate. Examples of further bleaches which may be used are sodium percarbonate, peroxy pyrophosphates, citrate perhydrates, and also H₂O₂-donating peracidic salts or peracids, such as perbenzoates, peroxophthalates, diperazelaic acid, phthaloimino peracid, or diperdodecanedioic acid. It is also possible when using bleaches to dispense with the use of surfactants and/or builders, so that pure bleach tablets can be produced. If such bleach tablets are to be used for laundering textiles, a combination of sodium percarbonate and sodium sesquicarbonate is preferred, independently of the further ingredients contained in the tablets. If detergent or bleach tablets are produced for machine dishwashing, bleaches from the group of organic bleaches can also be used. Typical organic bleaches are the diacyl peroxides, such as dibenzoyl peroxide, for example. Further typical organic bleaches are the peroxy acids, particular examples being the alkyl peroxy acids and the aryl peroxy acids. Preferred representatives are (a) peroxybenzoic acid and its ring-substituted derivatives, such as alkylperoxybenzoic acids, but also peroxy-α-naphthoic acid and magnesium monoperphthalate, (b) aliphatic or substituted aliphatic peroxy acids, such as peroxylauric acid, peroxystearic acid, E-phthalimidoperoxy caproic acid [phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxy dicarboxylic acids, such as 1,12-diperoxydecanedicarboxylic acid, 1,9-diperoxyazelaic acid, diperoxysebacic acid, diperoxybrassylic acid, the diperoxyphthalic acids, 2-decyldiperoxybutane-1, 4-dioic acid and N,N-terephthaloyldi(6-aminopercaproic acid) may also be used.

Bleaches may also be compounds which release chlorine or bromine. Among the suitable chlorine- or bromine-releasing materials examples include heterocyclic N-bromoamides and N-chloroamides, examples being trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethylhydantoin, are likewise suitable. The aforementioned compounds are used preferably in dishwashing compositions, although this is not intended to rule out their use in textile detergents.

In order to achieve an improved bleaching effect, bleach activators may be introduced into the compositions of the invention. Bleach activators which may be used are compounds which under perhydrolysis conditions give rise to aliphatic peroxo carboxylic acids having preferably 1 to 10 carbon atoms, in particular 2 to 4 carbon atoms, and/or substituted or unsubstituted perbenzoic acid. Suitable substances are those which carry O-acyl and/or N-acyl groups of the stated number of carbon atoms, and/or substituted or unsubstituted benzoyl groups. Preference is given to polyacylated alkylenediamines, especially tetraacetylethylenediamine (TAED), acylated triazine derivatives, especially 1,5-diacetyl-2,4-dioxohexahydro-1,3,5-triazine (DADHT), acylated glycolurils, especially 1,3,4,6-tetraacetylglycoluril (TAGU), N-acylimides, especially N-nonanoylsuccinimide (NOSI), acylated phenolsulfonates, especially n-nonanoyl- or isononanoyloxybenzenesulfonate (n- or iso-NOBS), acylated hydroxycarboxylic acids, such as triethyl O-acetylcitrate (TEOC), carboxylic anhydrides, especially phthalic anhydride, isatoic anhydride and/or succinic anhydride, carboxamides, such as N-methyldiacetamide, glycolide, acylated polyhydric alcohols, especially triacetin, ethylene glycol diacetate, isopropenyl acetate, 2,5-diacetoxy-2,5-dihydrofuran and the enol esters, and also acetylated sorbitol and mannitol and/or mixtures thereof (SORMAN), acylated sugar derivatives, especially pentaacetylglucose (PAG), pentaacetylfructose, tetraacetylxylose and octa-acetyllactose, and acetylated, optionally N-alkylated glucamine and gluconolactone, triazole and/or triazole derivatives and/or particulate caprolactams and/or caprolactam derivatives, preferably N-acylated lactams, for example, N-benzoylcaprolactam and N-acetyl-caprolactam. Hydrophilically substituted acylacetals and acyllactams are likewise used with preference. Combinations of conventional bleach activators may also be used. It is likewise possible to use nitrile derivatives such as cyanopyridines, nitrile quats and/or cyanamide derivatives. Preferred bleach activators are sodium 4-(octanoyloxy) benzenesulfonate, undecenoyloxybenzenesulfonate (UDOBS), sodium dodecanoyloxybenzenesulfonate (DOBS), decanoyloxybenzoic acid (DOBA, OBC 10) and/or dodecanoyloxybenzenesulfonate (OBS 12). Bleach activators of this kind are used in the customary range of amounts of from 0.01 to 20% by weight, preferably in amounts of from 0.1 to 15% by weight, in particular from 1% by weight to 10% by weight, based on the overall composition.

In addition to the conventional bleach activators, or instead of them, it is also possible to incorporate what are known as bleaching catalysts. These substances are bleach-boosting transition metal salts or transition metal complexes such as, for example, Mn-, Fe-, Co-, Ru- or Mo-salen complexes or -carbonyl complexes. Other bleaching catalysts which are suitable include Mn, Fe, Co, Ru, Mo, Ti, V and Cu complexes with N-containing tripod ligands, and also Co-, Fe-, Cu- and Ru-ammine complexes, preference being given to the use of those compounds described in DE 197 09 284 A1.

Suitable enzymes in the laundry detergents and cleaning products of the invention include in particular those from the classes of the hydrolases such as the proteases, esterases, lipases or lipolytic enzymes, amylases, glycosyl hydrolases, and mixtures of said enzymes. All of these hydrolases contribute to removing stains, such as proteinaceous, fatty or starchy marks. For bleaching, it is also possible to use oxidoreductases. Especially suitable enzymatic active substances are those obtained from bacterial strains or fungi such as Bacillus subtilis, Bacillus licheniformis, Streptomyces griseus, Coprinus cinereus and Humicola insolens, and also from genetically modified variants thereof. Preference is given to the use of proteases of the subtilisin type, and especially proteases obtained from Bacillus lentus. Of particular interest in this context are enzyme mixtures, examples being those of protease and amylase or protease and lipase or lipolytic enzymes, or of protease, amylase and lipase or lipolytic enzymes, or protease, lipase or lipolytic enzymes, but especially protease and/or lipase-containing mixtures or mixtures with lipolytic enzymes. Examples of such lipolytic enzymes are the known cutinases. Peroxidases or oxidases have also proven suitable in some cases. The suitable amylases include, in particular, alpha-amylases, iso-amylases, pullulanases, and pectinases.

The enzymes may be adsorbed on carrier substances or embedded in coating substances in order to protect them against premature decomposition. The proportion of the enzymes, enzyme mixtures or enzyme granules may be, for example, from about 0.1 to 5% by weight, preferably from 0.5 to about 4.5% by weight. In washing and cleaning processes, the enzymes may be used both during the heat treatment and in the rinse cycle after the heat treatment, i.e., in a mixture with the LCST substance.

Dyes and fragrances may be added to the compositions of the invention in order to enhance the esthetic appeal of the products which are formed and to provide the consumer with not only the performance but also a visually and sensorially “typical and unmistakable” product. As perfume oils and/or fragrances it is possible to use individual odorant compounds, examples being the synthetic products of the ester, ether, aldehyde, ketone, alcohol, and hydrocarbon types. Odorant compounds of the ester type are, for example, benzyl acetate, phenoxyethyl isobutyrate, p-tertbutylcyclohexyl acetate, linalyl acetate, dimethylbenzylcarbinyl acetate, phenylethyl acetate, linalyl benzoate, benzyl formate, ethyl methylphenylglycinate, allyl cyclo-hexylpropionate, styrallyl propionate, and benzyl salicylate. The ethers include, for example, benzyl ethyl ether; the aldehydes include, for example, the linear alkanals having 8-18 carbon atoms, citral, citronellal, citronellyloxyacetaldehyde, cyclamen aldehyde, hydroxycitronellal, lilial and bourgeonal; the ketones include, for example, the ionones, α-isomethylionone and methyl cedryl ketone; the alcohols include anethole, citronellol, eugenol, geraniol, linalool, phenylethyl alcohol, and terpineol; the hydrocarbons include primarily the terpenes such as limonene and pinene. Preference, however, is given to the use of mixtures of different odorants, which together produce an appealing fragrance note. Such perfume oils may also contain natural odorant mixtures, as obtainable from plant sources, examples being pine oil, citrus oil, jasmine oil, patchouli oil, rose oil or ylang-ylang oil. Likewise suitable are clary sage oil, camomile oil, clove oil, balm oil, mint oil, cinnamon leaf oil, lime blossom oil, juniperberry oil, vetiver oil, olibanum oil, galbanum oil and labdanum oil, and also orange blossom oil, neroli oil, orange peel oil, and sandalwood oil.

The fragrances may be incorporated directly into the detergents of the invention; alternatively, it may be advantageous to apply the fragrances to carriers, which strengthen the adherence of the perfume to the laundry and, by slowing the release of fragrance, provide for long-lasting fragrance of the textiles. Materials which have become established as such carriers are, for example, cyclodextrins, it being possible in addition for the cyclodextrin-perfume complexes to be coated with further auxiliaries. Compounding the fragrances with an LCST substance is also possible, so that they are released only in the rinse cycle, which results in a fragrance sensation when the machine is opened.

In one preferred embodiment of the present invention, the active substance compounded with the LCST substance is selected from the group of the surfactants. The presence of surfactants in the rinse cycle of a machine dishwashing process has a positive effect on the gloss and on the reduction of lime deposits. Active substances used in the rinse cycle are usually only low-foaming nonionic surfactants. The use of other surfactants, such as anionic surfactants, for example, is not, however, ruled out.

As further active substances which may be incorporated in compositions of the invention or else may be released as early as in the main wash cycle, the compositions used as machine dishwashing compositions may comprise corrosion inhibitors. The corrosion inhibitors are used in particular for protecting the ware or the machine, with special importance in the field of machine dishwashing being possessed, in particular, by silver protectants. The known substances of the prior art may be used. In general it is possible to use, in particular, silver protectants selected from the group consisting of triazoles, benzotriazoles, bisbenzotriazoles, aminotriazoles, alkylaminotriazoles, and transition metal salts or transition metal complexes. Particular preference is given to the use of benzotriazole and/or alkylaminotriazole. Frequently encountered in cleaning formulations, furthermore, are agents containing active chlorine, which may significantly reduce corrosion of the silver surface. In chlorine-free cleaners, use is made in particular of oxygen-containing and nitrogen-containing organic redox-active compounds, such as divalent and trivalent phenols, e.g., hydroquinone, pyrocatechol, hydroxyhydroquinone, gallic acid, phloroglucinol, pyrogallol, and derivatives of these classes of compound. Inorganic compounds in the form of salts and complexes, such as salts of the metals Mn, Ti, Zr, Hf, V, Co and Ce, also find frequent application. Preference is given in this context to the transition metal salts selected from the group consisting of manganese and/or cobalt salts and/or complexes, with particular preference cobalt ammine complexes, cobalt acetato complexes, cobalt carbonyl complexes, the chlorides of cobalt or of manganese and manganese sulfate. Similarly, zinc compounds may be used to prevent corrosion on the ware.

Laundry detergents and cleaning products used for textile laundering may include cationic surfactants as active substances which are released only in the rinse cycle.

Examples of the cationic surfactants which may be used in the compositions of the invention are, in particular, quaternary ammonium compounds. Preference is given to ammonium halides such as alkyltrimethylammonium chlorides, dialkyldimethylammonium chlorides and trialkylmethylammonium chlorides, examples being cetyltrimethylammonium chloride, stearyltrimethylammonium chloride, distearyldimethylammonium chloride, lauryldimethylammonium chloride, lauryldimethylbenzylammonium chloride, and tricetylmethylammonium chloride. The quaternized protein hydrolyzates are further cationic surfactants which may be used in accordance with the invention.

Likewise suitable in accordance with the invention are silicone oils such as, for example, the commercially available products Q2-7224 (manufacturer: Dow Corning; a stabilized trimethylsilylamodimethicone), Dow Corning 929 emulsion (comprising a hydroxyl-amino-modified silicone, which is also known as amodimethicone), SM-2059 (manufacturer: General Electric), SLM-55067 (manufacturer: Wacker), and also Abil®-Quat 3270 and 3272 (manufacturer: Th. Goldschmidt; diquaternary polymethylsiloxanes, Quaternium-80).

Alkylamidoamines, especially fatty acid amidoamines such as the stearylamidopropyldimethylamine obtainable under the designation Tego Amid®S 18, are notable not only for a good conditioning action but specifically for their good biodegradability.

Likewise highly biodegradable are quaternary ester compounds, known as “ester quats”, such as the methylhydroxyalkyldialkyloxyalkylammonium methosulfates marketed under the trade names Stepantex® and Dehyquat®.

An example of a quaternary sugar derivative which may be used as a cationic surfactant is the commercial product Glucquat®100, according to CTFA nomenclature a “Lauryl Methyl Gluceth-10 Hydroxypropyl Dimonium Chloride”.

The laundry detergents and cleaning products of the invention may be present either in solid form or in gel form or else as powders, granules, extrudates, single-phase or multiphase tablets, capsules in any desired shapes, or pouches, i.e., water-soluble film bags. The individual forms are producible by customary production processes, which are known to the skilled worker from the prior art.

The embodiments described below also apply to compositions in which the active substances are compounded without a carrier substance.

In one preferred embodiment of the present invention, the compositions of the invention are tablets having a plurality of phases, referred to below as phases A and B, which may be used in the various wash and rinse cycles, the phase(s) A comprising the carrier materials and also the active substances compounded with the LCST substance. The phase(s) A themselves may also be coated with the LCST substance.

The active substances in the phase(s) A are preferably not released until a process stage following a heat treatment, preferably in the rinse cycle, and the active substances of phases B are preferably released before or during the heat treatment, e.g., in the main wash cycle.

The phases A and B of the tablets may, in each case independently of one another, be produced by a compressing or noncompressing process. Compressing processes include, for example, tableting in a tableting press. Examples of noncompressing processes are sintering processes, microwave processes, melt processes, injection molding processes, and strand casting or extrusion processes.

The compositions may be produced in a manner known per se. In one possible embodiment, the phases A and B are produced separately and combined with one another subsequently.

In this embodiment, the phase A comprises as active substances surfactants, especially rinse aid surfactants, builders/cobuilders, bleaches, bleach activators, corrosion inhibitors, scale inhibitors, silver protectants, fragrances, and, if desired, further ingredients in small amounts.

It has proven particularly advantageous for the active substances of phase(s) A, and/or the phase(s) A itself (themselves), to be coated with the LCST substance. Depending on the solubility of the active substances in water it is possible first of all, as already described above, to apply a so-called undercoat with a water-soluble polymer and then to apply the LCST substance.

Phase B may in turn comprise a plurality of individual phases, which if desired are visually distinguishable on the outer face of the tablet, by means, for example, of a different surface nature, color, etc. The individual phases of phase B may also be obtained by means of different processes.

Phase B preferably constitutes a base tablet comprising customary ingredients for machine laundry detergents and cleaning products, especially dishwashing compositions, which already possesses cavities prefabricated for the incorporation of the phases A. One or more phases A may be introduced into the phase B. The combining of the phases A and B may be carried out, for example, by simple insertion, adhesive bonding, casting, or pressing.

In a further embodiment, the phases B are present in the form of a loose premix into which the phases A are inserted and which is subsequently pressed or otherwise hardened.

In the composition of the invention, a fraction of the active substances in incorporated in such a way that it is released not at all or only to a minor extent in the main wash cycle (and also in optional prewash cycles). This has the result that active substances display their activity only in the rinse cycle. In addition to this chemical compounding, physical compounding is necessary depending on the type of dishwasher or washing machine in order to ensure that the active substance particles are not pumped off when the water in the machine is changed and hence are no longer available for the rinse cycle.

Standard commercial dishwashers, for example upstream of the detergent-liquor pump, which pumps the water or cleaning solution from the machine after the individual cleaning cycles, comprise a sieve insert, intended to prevent clogging of the pump by food residues. The active substance used is preferably compounded in such a form, in terms of its size and shape, that it does not pass through the sieve insert of the dishwasher after the cleaning cycle, i.e., after exposure to agitation in the machine and to the detergent solution. This ensures that the active substance is present in the rinse cycle and is released only in this cycle, where it provides the desired rinse effect. Machine dishwashing compositions that are preferred in the context of the present invention are those wherein the formulation comprising the active substance, or the active substance itself, is compounded such that it has particle sizes of between 0.1 and 35 mm, preferably between 1.0 and 25 mm, and in particular between 2 and 20 mm.

In one embodiment of the present invention, the preparations or particles are admixed to customary pulverulent or granular machine dishwashing compositions.

In another preferred embodiment, the particles are processed together with the ingredients of the machine dishwashing compositions to form a combination product comprising detergent and rinse aid. Products of this kind are preferably tablets.

Combination products may be produced in a manner known per se. In one possible embodiment, the tablets and the particles of the invention are produced separately and then combined with one another, with the tablets possibly already having cavities prefabricated for the particles. Combination can then take place, for example, by simple insertion into the cavity or by adhesive bonding of the two solid components.

In another embodiment, the particles of the invention or the premix for them are processed to tablets in an appropriate tableting device together with the premix for the dishwashing composition.

In the laundry detergents and cleaning products of the invention, the active substance preparation having the sizes stated above may project from the matrix of the other particulate ingredients; alternatively, the other particles may likewise have sizes within the stated range so that, overall, a laundry detergent or cleaning product is formulated which comprises large detergent particles and active substance particles. Especially if the active substance particles are colored, i.e., have a red, blue, green, or yellow color, for example, it is advantageous on optical grounds for the appearance of the product, i.e., of the overall cleaning product, if these particles are visibly larger than the matrix comprising the particles of the other ingredients of the composition. Here, preference is given to inventive particulate laundry detergents and cleaning products which (without taking into account the rinse aid particles) have particle sizes of between 200 and 3000 μm, preferably between 300 and 2500 μm, and in particular between 400 and 2000 μm.

As well as the coloring of the active substance preparation, the visual attractiveness of such compositions may also be enhanced by means of contrasting coloration of the powder matrix or by the shape of these preparations. Since it is possible to use technically uncomplicated processes to produce the active substance preparations, it is readily possible to offer then in a very wide variety of shapes. In addition to the particle shape, which may have a spherical form, for example, cylindrical or cuboid particles may be produced and used. Other geometric shapes as well may be realized. Specific product designs may include, for example, star-shaped active substance preparations. It is also possible without problems to produce discs and shapes with plants and animal bodies as their basic outline, examples being tree, flower, blossom, sheep, fish, etc. Interesting visual attractions may also be created in this way by producing the active substance, if it is to be released in the rinse cycle of a machine dishwashing process, in the form of a stylized glass, in order to underscore visually the clear-rinse effect in the product as well. No limits are placed on the imagination in this context.

Where the cleaning products of the invention are formulated as a powder mixture, then—especially if there are large differences between the sizes of active substance preparation, e.g., rinse aid particles, and cleaning product matrix—on the one hand partial separation may occur when the pack is shaken, and on the other hand dosing may be different in two successive cleaning operations, since the user does not automatically dose equal quantities of cleaning product and active substance, e.g., rinse aid. If it is desired technically to use an identical quantity for each cleaning operation, this can be realized by the packaging—familiar to the skilled worker—of the compositions of the invention in water-soluble film pouches. The present invention also provides particulate laundry detergents including products where one dose unit is welded in a water-soluble film pouch.

By this means, the user need only insert a pouch, containing for example a cleaning product powder and a plurality of visually distinctive active substances incorporated in specific preparations, into the dispenser of his or her washing machine or dishwasher. This embodiment of the present invention is therefore a visually attractive alternative to conventional cleaning product tablets.

In another embodiment of the present invention, the composition of the invention is a textile detergent comprising cationic surfactants as active substances and ingredients which have been compounded with the LCST substance. As also described above for the dishwashing compositions, the textile detergents as well may be present in the form of a single-phase or multiphase tablet in analogy to the designs described.

Where the compositions of the invention are used as or in textile detergents, dosing may take place via the dispensing drawer or, by means of a dosing aid, directly into the drum. The particle size should in this case be such that it is larger than the size of the holes in the wash drum and/or in the sieves.

### EXAMPLES

### Example 1

A machine dishwashing composition was prepared as follows:

60% by weight of rinse aid surfactant Polytergent SLF 18B45 from Olin is applied to 15% by weight of the carrier material Polytrap from Advanced Polymer Systems, to give free-flowing granules. These granules are combined with 25% by weight of PEG 6000 and the mixture is compressed in a tableting press to give 1 g compacts. A coating of the LCST polymer is applied to these compacts by immersing them a number of times in an 8% strength solution of poly-N-isopropylacrylamide (PIPAAm) in 40:60 acetone/isopropanol. After the solvent has dried off, a coating of paraffin with a melting point of 50° C. is applied, again by immersion. This preparation is dosed in various ways together with a customary dishwashing composition (Somat; commercial product of the applicant):

1. It is placed together with commercially customary Somat powder detergent into the dosing compartment of the dishwasher.

2. It is inserted into a cavity of a Somat detergent tablet in loose or compacted form.

3. It is inserted in a tableting press into the loose premix of a Somat detergent tablet and is compressed together with the latter to form a tablet.

The function of these compounded detergents is subsequently tested in a commercially customary household dishwasher from Miele, G 683SC. In all cases it is found that, as desired, the Somat detergent, both as a powder and as a tablet, dissolves in the wash cycle (optionally 55° C. or 65° C. program) whereas the formulation comprising the rinse aid is retained until the beginning of the rinse cycle. It breaks down in the first few minutes of the rinse cycle and, as desired, releases the rinse aid surfactant.

### Example 2

Compacts with a higher proportion of rinse aid surfactant are formulated as follows:

72% by weight of the rinse aid surfactant Polytergent SLF 18B45 from Olin is applied to 18% by weight of the carrier material Polytrap from Advanced Polymer Systems, to produce free-flowing granules, which are combined with 10% by weight of PEG 6000 and pressed in a tableting press to form 1 g compacts. The subsequent procedure is as described in example 1.

### Example 3

The 3 components (Polytergent, Polytrap and PEG 6000) may likewise be combined in a mixer to give a very homogenous, readily shapable mixture. This mixture may be processed further, either in an extruder or as a melt, as described in example 1.

### Example 4

A machine dishwashing composition is prepared as follows:

As in example 1, 60% by weight of the rinse aid surfactant is applied to 20% by weight of carrier material to give free-flowing granules. 20% by weight of a 10% strength solution of PIPAAm in acetone is mixed into these granules. Following substantial evaporation of the solvent, the resulting granules are compressed in a tableting press to give approximately 1 g compacts. These compacts are subsequently coated with paraffin (melting point 50° C.) by the immersion process.

Compounding with the detergent, and the test of function, are performed as in example 1. Here again, it is observed that the compounded rinse aid formulation does not break down until the beginning of the rinse cycle, but then breaks down during the first few minutes of the rinse cycle, and releases the rinse aid.

### Example 5

The rinse aid formulation is prepared as in example 1 or example 2 except that there is no paraffin coating. The compact, comprising rinse aid and coated with LCST polymer, is inserted in a tableting press into the loose premix of a Somat detergent tablet and is compressed together with it to form a tablet, so that it is located approximately in the center of said Somat tablet. This form of compounding ensures that the LCST polymer does not come into contact with cold rinse water until the surrounding detergent has dissolved. Following its dissolution, the wash liquor is already so hot that the LCST is exceeded and the formulation containing the rinse aid does not break down before the beginning of the rinse cycle, but then breaks down in the first few minutes of the said cycle and, as desired, releases the rinse aid.

### Example 6

35% by weight of polyvinyl alcohol (Clariant PVAL Mowiol® 4-88), 15% polyvinyl acetate (Dow PVAc DLP 101) and 50% Polytergent® SLF 18B45 were mixed with one another at a temperature of 70° C. After cooling to room temperature, this mixture was divided into portions (1 g) and shaped into cylinders or beads, for example. Shaping was done by compression with an optional subsequent rounding. A coating of the LCST polymer was applied to these shapes by immersing them a number of times in an 8% strength solution of poly-N-isopropylacrylamide (PIPAAm) in 40:60 acetone/-isopropanol. After the solvent had dried off, a coating of paraffin with a melting point of 50° C. was applied, again by the immersion process. The detergent constituent produced in this way was compounded with a Somat tablet in accordance with example 1.

### Example 7

The active substance preparation from example 6, coated with the LCST polymer but not yet with paraffin, was inserted into an appropriately shaped cavity in the detergent tablet. Subsequently, the cavity was sealed with a substance having a melting point above the LCST (e.g., paraffin) or having retarded solubility.

### Example 8

45% by weight of polyvinyl alcohol (Ercol® 05/140), 15% of PEG 6000 and 40% of Polytergent® SLF 18B45 were mixed with one another at a temperature of 90° C. After cooling to room temperature, this mixture was processed further as in example 6.

### Example 9

Granules were produced from the following ingredients:

23.2% Polytergent SLF 18B45

51.4% sodium carbonate

14.8% zeolite X

3.2% water glass 3.3

0.4% salts

7% water

These granules were compressed on a tableting press to give tablets having a weight of 2.3 g each.

The following coatings were applied to these granules:

A first coat comprising PVAl (Erkol M05/20)

A further layer comprising polyisopropylacrylamide

A third layer comprising shellac

The compounding of the base tablet, and the test of function, were conducted in accordance with example 1.

### Example 10

Granules were produced with the following ingredients:

30% Polytergent SLF 18B45

46.7% Erkol M05/140

11.7% Erkol 48/20

5.8% Luviskol VA 64 (BASF)

5.8% water glass, overdried.

These granules were compressed to 1.5 g compacts using a tableting press. A coating of polyisopropylacrylamide was applied as in example 1 to these compacts. After the coating had dried, a further coat of shellac was applied.

Assembly with the base tablet, and the test of function, were carried out in accordance with example 1.

### Example 11

A coating was applied to the compacts of example 9 by immersing them in an alcoholic solution of Lutonal M 40 (polyvinyl methyl ether, BASF). Subsequently, a further coating of wax or shellac was applied.

Assembly with the base tablet, and the test of function, were carried out in accordance with example 1.

### Example 12

The following substances were mixed with one another:

13.34% Polytergent SLF 18B45

4.45% PEG 20 000

11.86% Erkol 05/140

1.19% paraffin m.p. 57° C.-60° C.

42.23% PEG 6000

26.93% Turpinal 2NZ

This mixture was heated with stirring until it had a castable consistency. It was then cast to give beads each weighing 4 g. After cooling, these beads were coated as in example 1 with PIPAAm and wax or with shellac, assembled together with the base tablet, and tested.

### Example 13

Granules produced from the following substances:

23.79% Polytergent SLF-18 B-45

61.86% sodium carbonate

3.33% sodium disilicate

10.25% water

In a fluidized bed coating unit, these granules were coated with 0.77% of polyvinyl alcohol Erkol M05/140. They were subsequently compressed on a tableting press to form 2.3 g compacts.

These compacts were coated with PIPPAm in accordance with example 1 and subsequently with wax or shellac. Thereafter, again in accordance with example 1, they were assembled together with a detergent tablet and tested.

What is claimed is:

1. A laundry detergent or cleaning product comprising customary ingredients, further comprising an active substance preparation which has been compounded with an LCST polymer.

2. A laundry detergent or cleaning product, comprising customary active substances and ingredients, in which the active substances have been compounded at least in part with an LCST polymer, wherein a fraction of the active substances has been applied to carrier materials.

3. The laundry detergent or cleaning product as claimed in claim 2, wherein the carrier materials are selected from zeolites, bentonites, silicates, e.g., water glasses, disilicates, carbonates, especially alkali metal carbonates, hydrogen carbonates, sulfates, phosphates, and also synthetic polymers, such as polyethylene glycols, polycarboxylates, crosslinked polycarboxylates, polyvinyl alcohols with different degrees of hydrolysis, or polyvinyl acetate, and organic oligocarboxylic acids which are solid at room temperature.

4. The laundry detergent or cleaning product as claimed in any of claims 1 to 3, wherein the active substance compounded with the LCST polymer remains at least partly unchanged following a heat treatment in a liquid medium in the main wash cycle and, following a temperature reduction, is released subsequent to the heat treatment.

5. The laundry detergent or cleaning product as claimed in any of claims 1 to 4, wherein the active substance has been coated with an LCST polymer.

6. The laundry detergent or cleaning product as claimed in any of claims 1 to 4, wherein the active substance preparation has been embedded in a matrix comprising an LCST substance.

7. The laundry detergent or cleaning product as claimed in any of claims 1 to 6, wherein the LCST polymer is selected from cellulose derivatives, mono- or di-N-alkylated acrylamides, copolymers of mono- or di-N-substituted acrylamides with acrylamides and/or acrylates and/or acrylic acids, polyvinyl alcohol and copolymers thereof, such as polyvinyl alcohol-vinyl acetate copolymers, polyvinyl methyl ethers, polyvinylcaprolactam, polyvinylpyrrolidone and its copolymers, polyisopropyloxazoline, polyamino acids and/or proteins.

8. The laundry detergent or cleaning product as claimed in claim 7, wherein the LCST polymer is selected from cellulose ethers, polyisopropylacrylamide, copolymers of polyisopropylacrylamide, and blends of these substances.

9. The laundry detergent or cleaning product as claimed in any of claims 1 to 8, wherein the lower critical separation temperature of the LCST substance is situated between 20° C. and 90° C.

10. The laundry detergent or cleaning product as claimed in any of claims 1 to 9, wherein the heat treatment is conducted at a temperature between 20° C. and 150° C., preferably between 30° C. and 90° C.

11. The laundry detergent or cleaning product as claimed in any of claims 1 to 10, wherein the compounded active substance preparation is coated with a further substance which at a temperature above the lower separation temperature of the LCST substance is soluble or which has a melting point above this temperature or has a retarded solubility in water.

12. The laundry detergent or cleaning product as claimed in claim 11, wherein the further substance is selected from hydrophilic polymers, such as polyvinyl alcohols, polyethylene glycols, water-soluble polysaccharides, water-soluble polyurethanes, xanthan, guar gum, alginates, chitosan, carrageenan, polysulfonates, shellac, polyacrylates and copolymers thereof and also any desired mixtures of the above.

13. The laundry detergent or cleaning product as claimed in any of claims 1 to 12, wherein the active substances, or active substances and carrier material, are coated with the LCST substance.

14. The laundry detergent or cleaning product as claimed in claim 13, wherein the active substances, or active substances and carrier material, have first been coated with a layer of a water-soluble polymer, to which the LCST substance is applied.

15. The laundry detergent or cleaning product as claimed in claim 14, wherein the layer of water-soluble polymer comprises polyvinyl alcohol.

16. The laundry detergent or cleaning product as claimed in any of claims 1 to 15, which is in solid to gel form, in the form of a powder, granules, extrudates, single-phase or multiphase tablets, capsule of any desired form, or pouches.

17. The laundry detergent or cleaning product as claimed in any of claims 1 to 16, which is a textile detergent and, as active substances, comprises textile handle components, enzymes, fragrances, dyes, fluorescence agents, optical brighteners, shrink preventatives, anticrease agents, antimicrobial active substances, germicides, fungicides, antioxidants, antistatics, easy-iron agents, repellency and impregnating agents, UV absorbers and any desired mixtures of the above.

18. The laundry detergent or cleaning product as claimed in any of claims 1 to 16, which is a machine dishwashing composition and comprises, as active substances and ingredients which have been compounded with the LCST substance, builders, cobuilders, acids, such as citric acid, amidosulfonic acid, citrate, hydrogen sulfate, surfactants, fragrances, dyes, bleaches, preferably an active chlorine carrier, and complexing agents, soil repellents, such as phosphonates, for example, including complexing surfactants, and also any desired mixtures of the above, and further customary ingredients.

19. The laundry detergent or cleaning product as claimed in claim 18, wherein the active substance preparation is a particulate rinse aid.

20. The laundry detergent or cleaning product as claimed in claim 19, wherein the particulate rinse aid has particle sizes of between 0.1 and 35 mm, preferably between 1.0 and 20 mm, and in particular between 2 and 20 mm.

21. The laundry detergent or cleaning product as claimed in claim 18, which has phases A and B, the phase(s) A comprising carrier materials and also the active substances compounded with the LCST substance.

22. The laundry detergent or cleaning product as claimed in claim 21, wherein the phase(s) A comprise(s) active substances which are released in a cycle after the actual dishwashing, preferably in the rinse cycle.

23. The laundry detergent or cleaning product as claimed in claim 22, wherein the active substances are selected from surfactants, especially rinse aid surfactants, builder/cobuilders, bleaches, bleach activators, corrosion inhibitors, scale inhibitors, silver protectants, fragrances and also, if desired, further ingredients in small amounts.

24. The laundry detergent or cleaning product as claimed in any of claims 21 to 23, wherein phase B is a base tablet comprising customary ingredients for machine dishwashing compositions.

25. The laundry detergent or cleaning product as claimed in any of claims 21 to 24, wherein phase B comprises a plurality of individual phases which if desired are visually distinguishable on the outer face of the tablet.
